(19) United States
(12) Patent Application Publication
(10) Pub. No.: US 2026/0067990 A1
(43) Pub. Date: Mar. 5, 2026

(54) COMMUNICATION METHOD

(71) Applicant: KYOCERA Corporation, Kyoto (JP)

(72) Inventors: Masato FUJISHIRO, Yokohama-shi, Kanagawa (JP); Henry CHANG, San Diego, CA (US)

(73) Assignee: KYOCERA Corporation, Kyoto (JP)

(21) Appl. No.: 19/384,700

(22) Filed: Nov. 10, 2025

Related U.S. Application Data
(63) Continuation of application No. PCT/JP2024/017464, filed on May 10, 2024.
(60) Provisional application No. 63/501,466, filed on May 11, 2023.

(51) Int. Cl. H04W 76/40; H04W 76/27

(52) U.S. Cl. CPC H04W 76/40; H04W 76/27

(57) ABSTRACT

A communication method performed by a user equipment in a mobile communication system providing a multicast/broadcast service (MBS) includes receiving a multicast session in a radio resource control (RRC) inactive state from a network by using a first multicast radio bearer (MRB) for the RRC inactive state, maintaining the first MRB until a predetermined condition is satisfied even after transitioning from the RRC inactive state to an RRC connected state, and receiving point-to-multipoint (PTM) configuration in the RRC connected state from the network, the PTM configuration including a configuration of a second MRB for receiving the multicast session in the RRC connected state. The predetermined condition includes receiving, by the user equipment, the PTM configuration from the network.

### RELATED APPLICATIONS

The present application is a continuation based on PCT Application No. PCT/JP2024/017464, filed on May 10, 2024, which claims the benefit of U.S. Provisional Patent Application No. 63/501,466 filed on May 11, 2023. The content of which is incorporated by reference herein in their entirety.

### TECHNICAL FIELD

The present disclosure relates to a communication method used in a mobile communication system.

### BACKGROUND

The 3rd Generation Partnership Project (3GPP) has defined the technical specifications of New Radio (NR) that is a radio access technology of the fifth generation (5G). NR has features such as high speed, large capacity, high reliability, and low latency as compared to Long Term Evolution (LTE) that is a radio access technology of the fourth generation (4G). The 3GPP has defined technical specifications of multicast/broadcast services (MBS) of 5G/NR.

In 3GPP Release 17, MBS multicast reception (i.e., multicast reception) is possible only for a user equipment in a radio resource control (RRC) connected state (see, for example, Non-Patent Document 1). On the other hand, in 3GPP Release 18, technical specifications are scheduled to be extended so that a user equipment in an RRC inactive state can perform multicast reception.

### CITATION LIST

### Non-Patent Literature

Non-Patent Document 1: 3GPP Technical Specification: TS 38.300 V17.4.0

### SUMMARY

In a first aspect, a communication method is performed by a user equipment in a mobile communication system for providing a multicast/broadcast service (MBS). The communication method includes receiving a multicast session in a radio resource control (RRC) inactive state from a network by using a first multicast radio bearer (MRB) for the RRC inactive state, maintaining the first MRB until a predetermined condition is satisfied even after transitioning from the RRC inactive state to an RRC connected state, and receiving point-to-multipoint (PTM) configuration in the RRC connected state from the network, the PTM configuration including a configuration of a second MRB for receiving the multicast session in the RRC connected state. The predetermined condition includes receiving, by the user equipment, the PTM configuration from the network.

In a second aspect, a communication method is performed by a user equipment in a mobile communication system for providing a multicast/broadcast service (MBS). The communication method includes receiving a multicast session in a radio resource control (RRC) inactive state from a network by using a multicast radio bearer (MRB) for the RRC inactive state, transitioning from the RRC inactive state to an RRC connected state, stopping the receiving of the multicast session using the MRB even after transitioning to the RRC connected state based on a cause being update of a point-to-multipoint (PTM) configuration for the multicast session, and continuing the receiving of the multicast session using the MRB even after transitioning to the RRC connected state based on a different cause from the cause.

### BRIEF DESCRIPTION OF THE DRAWINGS

FIG. 1 is a diagram illustrating a configuration example of a mobile communication system according to an embodiment.

FIG. 2 is a diagram illustrating a configuration example of a UE (user equipment) according to an embodiment.

FIG. 3 is a diagram illustrating a configuration example of a gNB (base station) according to the embodiment.

FIG. 4 is a diagram illustrating a configuration of a protocol stack of a radio interface of a user plane handling data.

FIG. 5 is a diagram illustrating a configuration of a protocol stack of a radio interface of a control plane handling signaling (control signal).

FIG. 6 is a flowchart illustrating a basic operation example of the UE for a first operation pattern according to the embodiment.

FIG. 7 is a diagram illustrating an example of an operation of the mobile communication system for the first operation pattern according to the embodiment.

FIG. 8 is a flowchart illustrating an operation example of the UE for a second operation pattern according to the embodiment.

FIG. 9 is a diagram illustrating an initial configuration procedure of an ongoing session (FIG. 9A) and a stopped session (FIG. 9B).

### DESCRIPTION OF EMBODIMENTS

According to an embodiment, a mobile communication system is described with reference to the drawings. In the description of the drawings, the same or similar parts are denoted by the same or similar reference signs.

### (1) System Configuration Example

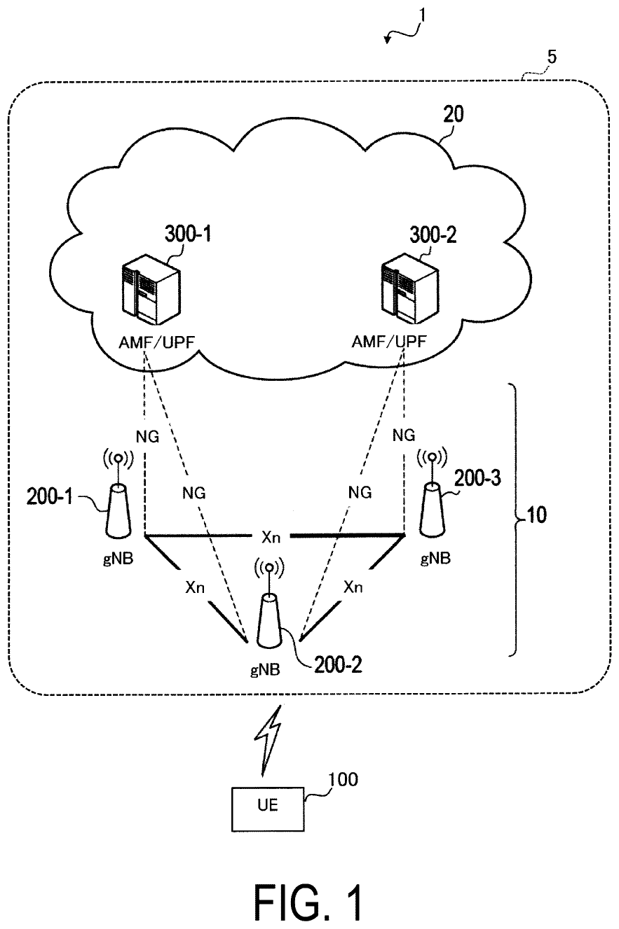

FIG. 1 is a diagram illustrating a configuration example of a mobile communication system 1 according to the embodiment. The mobile communication system 1 complies with the 5th Generation System (5GS) of the 3GPP standard. The description below takes the 5GS as an example, but Long Term Evolution (LTE) system may be at least partially applied to the mobile communication system. Alternatively, a sixth generation (6G) system may be at least partially applied to the mobile communication system.

The mobile communication system 1 includes User Equipment (UE) 100, a 5G radio access network (Next Generation Radio Access Network (NG-RAN)) 10, and a 5G Core Network (5GC) 20. Hereinafter, the NG-RAN 10 may be simply referred to as a RAN 10. The 5GC 20 may be simply referred to as a core network (CN) 20. The RAN 10 and the CN 20 constitute a network of the mobile communication system 1.

The UE 100 is a mobile wireless communication apparatus. The UE 100 may be any apparatus as long as the UE 100 is used by a user. Examples of the UE 100 include a mobile phone terminal (including a smartphone) and/or a tablet terminal, a notebook PC, a communication module (including a communication card or a chipset), a sensor or an apparatus provided on a sensor, a vehicle or an apparatus provided on a vehicle (Vehicle UE), and a flying object or an apparatus provided on a flying object (Aerial UE).

The NG-RAN 10 includes base stations (referred to as “gNBs” in the 5G system) 200. The gNBs 200 are interconnected via an Xn interface which is an inter-base station interface. Each gNB 200 manages one or more cells. The gNB 200 performs wireless communication with the UE 100 that has established a connection to the cell of the gNB 200. The gNB 200 has a radio resource management (RRM) function, a function of routing user data (hereinafter simply referred to as “data”), a measurement control function for mobility control and scheduling, and the like. The “cell” is used as a term representing a minimum unit of a wireless communication area. The “cell” is also used as a term representing a function or a resource for performing wireless communication with the UE 100. One cell belongs to one carrier frequency (hereinafter, simply referred to as a “frequency”).

Note that the gNB can be connected to an Evolved Packet Core (EPC) corresponding to a core network of LTE. An LTE base station can also be connected to the 5GC. The LTE base station and the gNB can be connected via an inter-base station interface.

The 5GC 20 includes an Access and Mobility Management Function (AMF) and a User Plane Function (UPF) 300. The AMF performs various types of mobility controls and the like for the UE 100. The AMF manages mobility of the UE 100 by communicating with the UE 100 by using Non-Access Stratum (NAS) signaling. The UPF controls data transfer. The AMF and UPF are connected to the gNB 200 via an NG interface which is an interface between a base station and the core network.

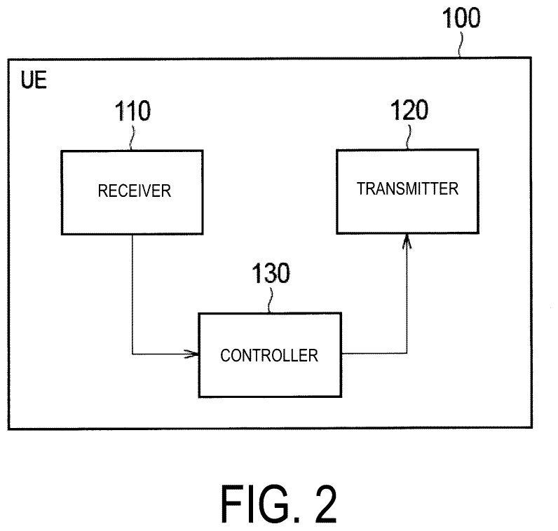

FIG. 2 is a diagram illustrating a configuration example of the UE 100 (user equipment) according to the embodiment. The UE 100 includes a receiver 110, a transmitter 120, and a controller 130. The receiver 110 and the transmitter 120 constitute a wireless communicator that performs wireless communication with the gNB 200.

The receiver 110 performs various receptions under the control of the controller 130. The receiver 110 includes an antenna and a reception device. The reception device converts a radio signal or a terahertz wave signal received through the antenna into a baseband signal (a reception signal) and outputs the resulting signal to the controller 130.

The transmitter 120 performs various transmissions under the control of the controller 130. The transmitter 120 includes an antenna and a transmission device. The transmission device converts a baseband signal (a transmission signal) output by the controller 130 into a radio signal or a terahertz wave signal and transmits the resulting signal through the antenna.

The controller 130 performs various controls and processes in the UE 100. Such processing includes processing of respective layers to be described later. The operations of the UE 100 described above and below may be operations under the control of a controller 130. The controller 130 includes at least one processor and at least one memory. The memory stores a program to be executed by the processor and information to be used for processing in the processor. The processor may include a baseband processor and a Central Processing Unit (CPU). The baseband processor performs modulation and demodulation, coding and decoding, and the like of a baseband signal. The CPU executes the program stored in the memory to thereby perform various types of processing.

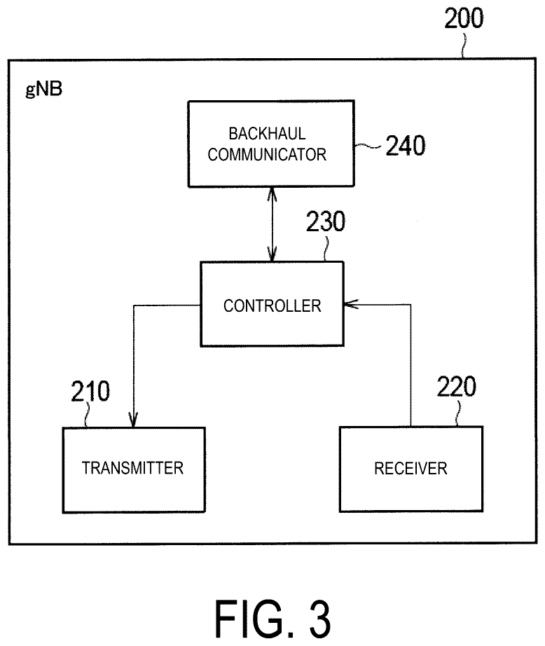

FIG. 3 is a diagram illustrating a configuration example of the gNB 200 (the base station) according to the embodiment. The gNB 200 includes a transmitter 210, a receiver 220, a controller 230, and a backhaul communicator 240. The transmitter 210 and the receiver 220 constitute a wireless communicator that performs wireless communication with the UE 100. The backhaul communicator 240 constitutes a network communicator that performs communication with the CN 20.

The transmitter 210 performs various transmissions under the control of the controller 230. The transmitter 210 includes an antenna and a transmission device. The transmission device converts a baseband signal (a transmission signal) output by the controller 230 into a radio signal or a terahertz wave signal and transmits the resulting signal through the antenna.

The receiver 220 performs various types of reception under control of the controller 230. The receiver 220 includes an antenna and a reception device. The reception device converts a radio signal or a terahertz wave signal received through the antenna into a baseband signal (a reception signal) and outputs the resulting signal to the controller 230.

The controller 230 performs various types of control and processing in the gNB 200. Such processing includes processing of respective layers to be described later. The operations of the gNB 200 described above and below may be also performed under the control of the controller 230. The controller 230 includes at least one processor and at least one memory. The memory stores a program to be executed by the processor and information to be used for processing in the processor. The processor may include a baseband processor and a CPU. The baseband processor performs modulation and demodulation, coding and decoding, and the like of a baseband signal. The CPU executes the program stored in the memory to thereby perform various types of processing.

The backhaul communicator 240 is connected to a neighboring base station via an Xn interface which is an inter-base station interface. The backhaul communicator 240 is connected to the AMF/UPF 300 via an NG interface which is an interface between a base station and the core network. Note that the gNB 200 may include a Central Unit (CU) and a Distributed Unit (DU) (i.e., functions are divided), and both units may be connected via an F1 interface that is a fronthaul interface.

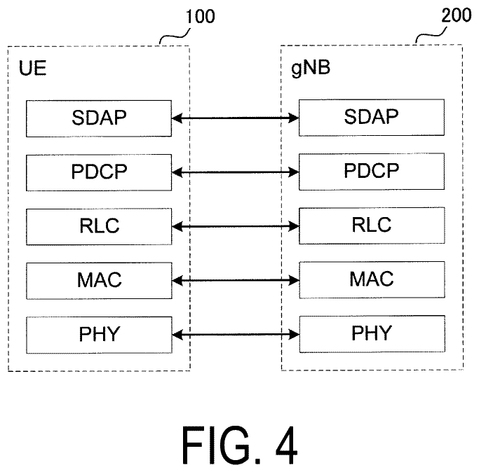

FIG. 4 is a diagram illustrating a configuration of a protocol stack of a radio interface of a user plane handling data.

A radio interface protocol of the user plane includes a PHYsical (PHY) layer, a Medium Access Control (MAC) layer, a Radio Link Control (RLC) layer, a Packet Data Convergence Protocol (PDCP) layer, and a Service Data Adaptation Protocol (SDAP) layer.

The PHY layer performs encoding/decoding, modulation/demodulation, antenna mapping/demapping, and resource mapping/demapping. Data and control information are transmitted between the PHY layer of the UE 100 and the PHY layer of the gNB 200 via a physical channel. Note that the PHY layer of the UE 100 receives downlink control information (DCI) transmitted from the gNB 200 over a physical downlink control channel (PDCCH). Specifically, the UE 100 performs blind decoding of the PDCCH by using a radio network temporary identifier (RNTI) and acquires a successfully decoded DCI as a DCI addressed to the UE. CRC parity bits scrambled by the RNTI are added to the DCI transmitted from the gNB 200.

The MAC layer performs priority control of data, retransmission processing through hybrid ARQ (HARQ: Hybrid Automatic Repeat reQuest), a random access procedure, and the like. Data and control information are transmitted between the MAC layer of the UE 100 and the MAC layer of the gNB 200 via a transport channel. The MAC layer of the gNB 200 includes a scheduler. The scheduler decides transport formats (transport block sizes, Modulation and Coding Schemes (MCSs)) in the uplink and the downlink and resource blocks to be allocated to the UE 100.

The RLC layer transmits data to the RLC layer on the reception side by using functions of the MAC layer and the PHY layer. Data and control information are transmitted between the RLC layer of the UE 100 and the RLC layer of the gNB 200 via a logical channel.

The PDCP layer performs header compression/decompression, encryption/decryption, and the like.

The SDAP layer performs mapping between an IP flow as the unit of Quality of Service (QOS) control performed by a core network and a radio bearer as the unit of QoS control performed by an Access Stratum (AS). Note that, when the RAN is connected to the EPC, the SDAP need not be provided.

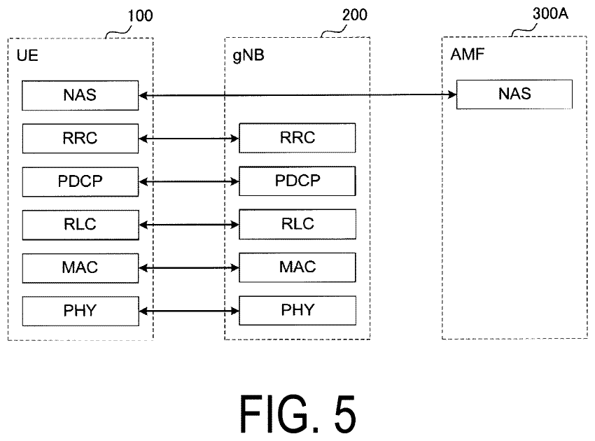

FIG. 5 is a diagram illustrating a configuration of a protocol stack of a radio interface of a control plane handling signaling (a control signal).

The protocol stack of the radio interface of the control plane includes a Radio Resource Control (RRC) layer and a Non-Access Stratum (NAS) layer instead of the SDAP layer illustrated in FIG. 4.

RRC signaling for various configurations is transmitted between the RRC layer of the UE 100 and the RRC layer of the gNB 200. The RRC layer controls a logical channel, a transport channel, and a physical channel according to establishment, re-establishment, and release of a radio bearer. When connection (RRC connection) is established between RRC of the UE 100 and RRC of the gNB 200, the UE 100 is in an RRC connected state. When connection (RRC connection) is not established between the RRC of the UE 100 and the RRC of the gNB 200, the UE 100 is in an RRC idle state. When the connection between the RRC of the UE 100 and the RRC of the gNB 200 is suspended, the UE 100 is in an RRC inactive state.

The NAS layer (also simply referred to as “NAS”), which is located above the RRC layer, performs session management, mobility management, and the like. NAS signaling is transmitted between the NAS layer of the UE 100 and the NAS layer of an AMF 300A. The UE 100 includes an application layer other than the protocol of the radio interface. The layer below the NAS layer is referred to as an AS layer (also simply referred to as “AS”).

### (2) Overview of MBS

The mobile communication system 1 can perform delivery with high resource efficiency by using the multicast/broadcast service (MBS).

### (2.1) MBS Broadcast

In a case of the broadcast communication services (also referred to as “MBS broadcast”), the same service and the same specific content data are provided simultaneously to every UE 100 in a geographic area. That is, every UE 100 in the broadcast service area is permitted to receive the data. The broadcast communication services are delivered to the UE 100 using a broadcast session that is a type of MBS session. The UE 100 can receive the broadcast session in any state of the RRC idle state, the RRC inactive state, and the RRC connected state. Note that the MBS session is identified by an MBS session ID (e.g., Temporary Mobile Group Identity (TMGI)).

Point-to-Multipoint (PTM) delivery is applied to the broadcast communication service. For the PTM transmission, the gNB 200 delivers a single copy of an MBS packet to a set (group) of a plurality of UEs 100. For example, the gNB 200 uses a group-common PDCCH with a cyclic redundancy code (CRC) scrambled by a group RNTI (G-RNTI) which is a group-common RNTI to schedule a group-common PDSCH scrambled by the G-RNTI.

For the broadcast communication service, the UE 100 receives a broadcast session in the following procedure. First, the UE 100 receives system information block type 20 (SIB20) from the gNB 200. The SIB20 includes a configuration of a multicast control channel (MCCH), which is a type of logical channel. Second, the UE 100 receives the MCCH from the gNB 200 based on the SIB20. The MCCH includes a PTM configuration. The PTM configuration carries a configuration for a multicast traffic channel (MTCH), which is a type of logical channel, and a configuration of a broadcast multicast radio bearer (MRB), which is an MRB for broadcast session. The information transmitted by the MCCH may be referred to as MBS broadcast control information. Third, the UE 100 receives the MTCH based on the MCCH. The MTCH transmits a broadcast session (specifically, MBS data belonging to the broadcast session).

Note that the MCCH is a PTM downlink channel for transmitting the MBS broadcast control information associated with one or more MTCHs from the network 10 to the UE 100. The MTCH is a PTM downlink channel for transmitting MBS data of a multicast session and/or a broadcast session from the network 10 to the UE 100.

### (2.2) MBS Multicast

For a multicast communication service (also referred to as “MBS multicast”), the same service and the same specific content data are simultaneously provided to a specific UE set. That is, not every UE 100 in the multicast service area is permitted to receive data. The multicast communication service is delivered to the UE 100 using a multicast session that is a type of MBS session.

The UE 100 can receive a multicast session only after joining the multicast session (session join). The joining the multicast session may mean that the UE 100 is registered as being capable of receiving the multicast session in the network 5 (the CN 20).

For the multicast communication service, in 3GPP Release 17, only the UE 100 in the RRC connected state can receive a multicast session. On the other hand, in 3GPP Release 18, enhancement will be made such that the UE 100 in the RRC inactive state also can receive a multicast session.

### (2.2.1) Multicast Reception in RRC Connected State

The UE 100 in the RRC connected state can receive a multicast session (specifically, MBS data belonging to a multicast session) by using mechanisms such as Point-to-Point (PTP) delivery and/or Point-to-Multipoint (PTM) delivery.

For the multicast communication service, the UE 100 in the RRC connected state receives a multicast session in the following procedure. First, the UE 100 receives an RRC Reconfiguration message from the gNB 200. The RRC Reconfiguration message is a message transmitted on a dedicated control channel (DCCH). The RRC Reconfiguration message transmits a configuration for an MTCH for multicast session reception and a configuration of a multicast MRB which is an MRB for multicast session. Second, the UE 100 receives an MTCH based on the RRC Reconfiguration message. The MTCH transmits a multicast session (specifically, MBS data belonging to the multicast session). Note that the configuration for the MTCH (MTCH configuration), MTCH configuration, is a configuration for MTCH reception, and includes, for example, at least one selected from the group consisting of a group identifier (G-RNTI), a discontinuous reception configuration (DRX configuration or scheduling information: MTCH transmission ON time, MTCH transmission cycle, reference time and time offset, HARQ retransmission configuration), a layer 2 configuration (PDCP configuration, RLC configuration), and a physical channel configuration (PDCCH configuration, PDSCH configuration, SSB mapping configuration).

### (2.2.2) Multicast Reception in RRC Inactive State

The UE 100 in the RRC inactive state may receive a multicast session (specifically, MBS data belonging to the multicast session) by using the mechanism of the PTM delivery.

For the multicast communication service, the UE 100 in the RRC inactive state can receive a multicast session in the following procedure. First, the UE 100 in the RRC inactive state receives a newly introduced system information block (also referred to as a “new SIB”) from the gNB 200. The new SIB includes a configuration of a newly introduced MCCH (also referred to as a “multicast MCCH”). Second, the UE 100 in the RRC inactive state receives a multicast MCCH based on the new SIB from the gNB 200. The multicast MCCH includes a PTM configuration. The PTM configuration carries a configuration for an MTCH for multicast session reception and a configuration of a multicast MRB which is an MRB for multicast session. Third, the UE 100 in the RRC inactive state receives an MTCH based on the multicast MCCH. The MTCH transmits a multicast session (specifically, MBS data belonging to the multicast session).

When the gNB 200 configures the UE 100 to receive multicast in the RRC inactive state, the gNB 200 can transmit the PTM configuration using an RRC release message including a suspend configuration to the UE 100. In this case, the UE 100, upon receiving the RRC Release message including the PTM configuration from the gNB 200, transitions to the RRC inactive state and receives the multicast session in the RRC inactive state.

### (3) System Operation Example

Hereinafter, an operation for the multicast reception in the RRC inactive state is described. In the present embodiment, a scenario is assumed in which the UE 100 in the RRC inactive state that performs reception of a multicast session (also referred to as multicast reception) transitions to the RRC connected state.

Note that in the present embodiment, it is assumed that the MRB for multicast reception in the RRC inactive state (also referred to as a “first MRB” or “MRB for RRC inactive state”) and the MRB for multicast reception in the RRC connected state (also referred to as a “second MRB” or “MRB for RRC connected state”) are basically different bearers.

### (3.1) First Operation Pattern

When the UE 100 that performs the multicast reception in the RRC inactive state using the MRB for RRC inactive state transitions to the RRC connected state through the RRC connection resume, the point-to-multipoint (PTM) configuration including the configuration of the MRB for RRC connected state is transmitted from the network 5 (gNB 200) to the UE 100. Then, the UE 100 starts multicast reception using the MRB for RRC connected state. Here, if the UE 100 discards the MRB for RRC inactive state upon the RRC connection resume, the multicast reception is interrupted before the multicast reception using the MRB for RRC connected state is started, and a loss may occur in the multicast data to be received. Thus, there exists a concern that continuity of multicast reception cannot be secured.

A first operation pattern is an operation pattern that makes it easy to secure the continuity of multicast reception even when the UE 100 that performs multicast reception in the RRC inactive state transitions to the RRC connected state.

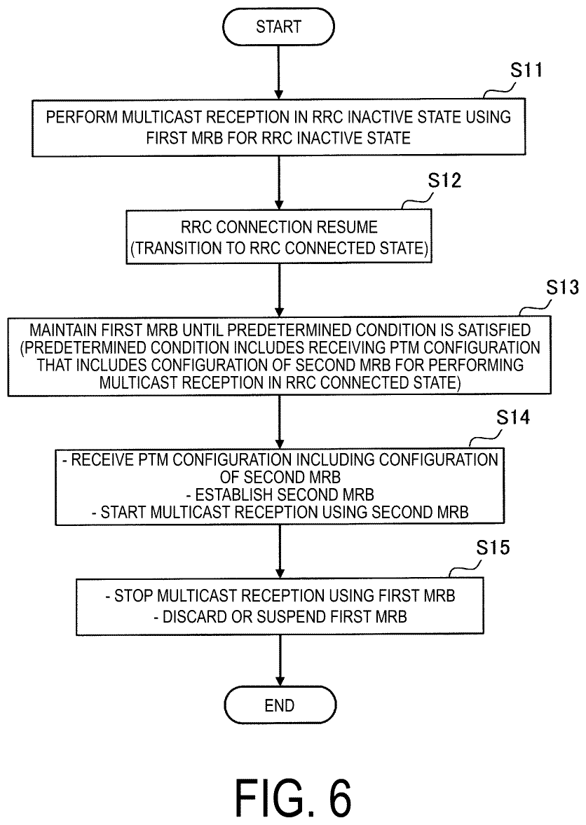

FIG. 6 is a flowchart illustrating a basic operation example of the UE 100 for the first operation pattern. It is assumed that, prior to this operation, the UE 100 has already joined a certain multicast session (referred to as “multicast session #1”), received a PTM configuration including a configuration of an MRB for RRC inactive state for receiving the multicast session #1 from the network 5, and established the MRB for RRC inactive state. Note that the joining the multicast session #1 may mean that the UE 100 is registered in the CN 20 in association with the multicast session #1.

In step S11, the UE 100 in the RRC inactive state receives the multicast session #1 using a first MRB for RRC inactive state from the network 5.

In step S12, the UE 100 in the RRC inactive state performs the RRC connection resume with the network 5 to transition the RRC connected state.

In step S13, the UE 100, even after transitioning from the RRC inactive state to the RRC connected state, maintains the first MRB (that is, the reception processing of the multicast session #1 using the first MRB) until a predetermined condition is satisfied. The predetermined condition includes receiving, by the UE 100, a PTM configuration including a configuration of a second MRB for receiving the multicast session #1 in the RRC connected state from the network 5.

In step S14, the UE 100 in the RRC connected state receives the PTM configuration including the configuration of the second MRB from the network 5. In response to receiving the PTM configuration, the UE 100 establishes the second MRB and starts receiving the multicast session #1 using the second MRB.

In step S15, the UE 100 in the RRC connected state stops receiving the multicast session #1 using the first MRB, based on receiving the PTM configuration including the configuration of the second MRB from the network 5. The UE 100 may stop receiving the multicast session #1 using the first MRB in response to establishing the second MRB or starting receiving the multicast session #1 using the second MRB. The UE 100 may suspend or discard the first MRB.

According to such an operation, even when the UE 100 that performs the multicast reception in the RRC inactive state using the MRB for RRC inactive state (first MRB) transitions to the RRC connected state through the RRC connection resume, the UE 100 can continue the multicast reception using the first MRB until the predetermined condition indicating that the MRB for RRC connected state (second MRB) is available is satisfied. Thus, the continuity of the multicast reception can be secured.

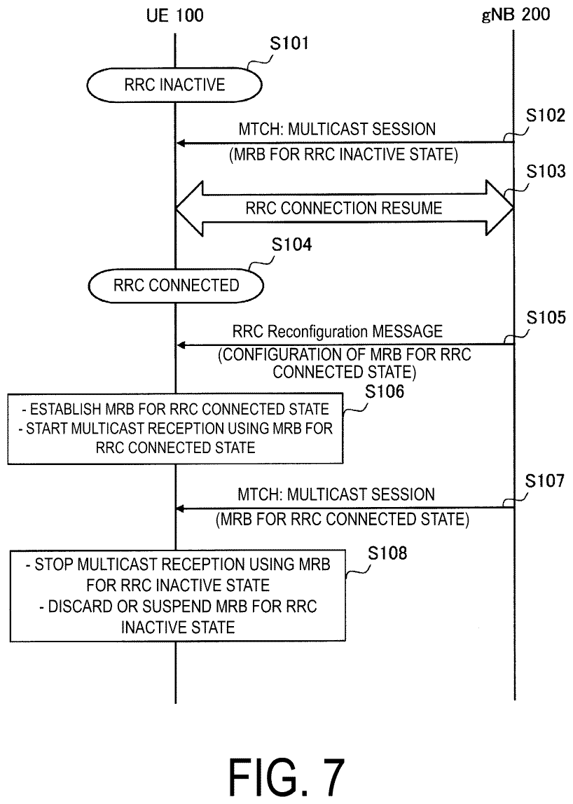

FIG. 7 is a diagram illustrating an example of an operation of the mobile communication system 1 for the first operation pattern.

In step S101, the UE 100 is in the RRC inactive state in the cell (serving cell) of the gNB 200.

In step S102, the gNB 200 transmits (multicasts) the multicast session #1 on the MTCH using the MRB for RRC inactive state to the UE 100. The UE 100 in the RRC inactive state receives the multicast session #1 on the MTCH using the MRB for RRC inactive state.

In step S103, the UE 100 performs RRC connection resume due to reception of paging from the network 5, generation of uplink data, deterioration of multicast reception quality, or the like. The RRC connection resume includes transmitting an RRC resume request message from the UE 100 to the gNB 200.

In step S104, the UE 100 transitions to the RRC connected state through the RRC connection resume. At this point of time, the UE 100 continues receiving the multicast session #1 using the MRB for RRC inactive state.

In Step S105, the gNB 200 transmits, in an RRC Reconfiguration message, the PTM configuration including the configuration of the MRB for RRC connected state for receiving the multicast session #1 in the RRC connected state to the UE 100. The UE 100 in the RRC connected state receives the RRC Reconfiguration message.

In the step S106, the UE 100 in the RRC connected state establishes the MRB for RRC connected state in response to receiving the RRC Reconfiguration message of the step S105, and starts receiving the multicast session #1 using the MRB for RRC connected state.

In step S107, the gNB 200 transmits (multicasts) the multicast session #1 on the MTCH using the MRB for RRC connected state to the UE 100. The UE 100 in the RRC connected state receives the multicast session #1 on the MTCH using the MRB for RRC connected state.

In the step S108, the UE 100 in the RRC connected state stops the reception processing of the multicast session #1 via the MRB for RRC inactive state and discards or suspends the MRB for RRC inactive state, which is triggered by any of the RRC Reconfiguration message of the step S105 being included an MRB configuration for RRC connected state, the MRB for RRC connected state being established, and the multicast reception being normally started via the MRB for RRC connected state. Note that discarding the MRB for RRC inactive state may be discarding (releasing) the configuration of the MRB for RRC inactive state. Suspending the MRB for RRC inactive state may be stopping the use of the MRB for RRC inactive state while maintaining the configuration of the MRB for RRC inactive state.

In this operation example, an example is described in which the number of multicast sessions received by the UE 100 is one, but the UE 100 may receive a plurality of multicast sessions. The UE 100 may determine a correspondence relationship between the MRB for RRC inactive state and the MRB for RRC connected state based on whether the MBS session IDs associated with the respective MRBs match.

When the UE 100 is receiving a plurality of multicast sessions, the UE 100 may stop (discard/suspend) the reception of the MRB for RRC inactive state, which is triggered by some of a plurality of MRBs for RRC connected state corresponding to the plurality of multicast sessions being configured (established/started to be received). The UE 100 may stop (discard/suspend) the reception of the MRB for RRC inactive state, which is triggered by all of the plurality of MRBs for RRC connected state being configured (established/started to be received). The some of the MRBs for RRC connected state may be determined according to the number or the MBS session ID designated from the network 5.

### (3.2) Second Operation Pattern

A second operation pattern is described focusing on differences from the first operation pattern described above. The second operation pattern can be implemented in combination with the first operation pattern described above.

The first operation pattern described above assumes that the MRB for RRC connected state is configured for the UE 100 from the network 5 after the UE 100 transitions to the RRC connected state through the RRC connection resume. However, when the configuration of the MRB for RRC inactive state does not need to be changed, it is preferable that the MRB for RRC inactive state can be continued to be used even after the UE 100 transitions to the RRC connected state through the RRC connection resume. The MRB for RRC inactive state being continued to be used makes it easy to secure the continuity of multicast reception.

The second operation pattern is an operation pattern that makes it easy to secure the continuity of multicast reception even when the UE 100 that performs multicast reception in the RRC inactive state transitions to the RRC connected state, using a method different from the first operation pattern.

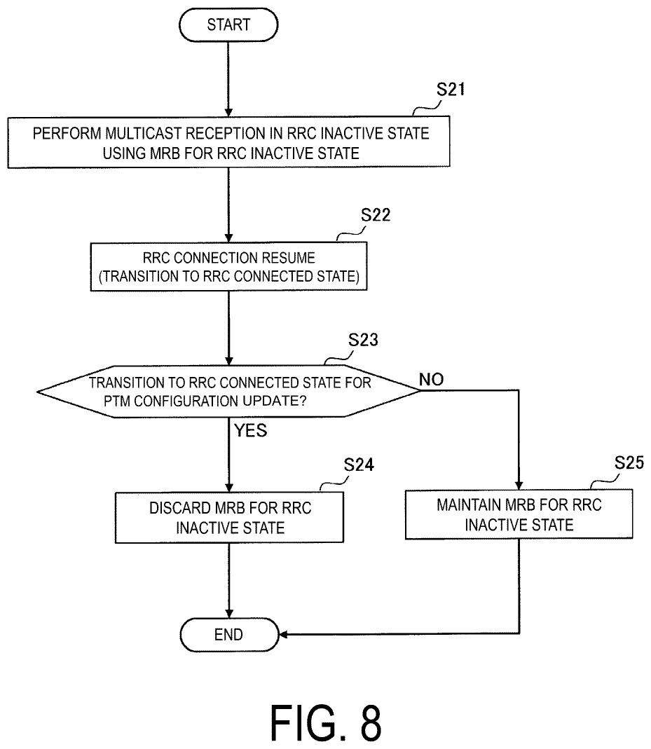

FIG. 8 is a flowchart illustrating a basic operation example of the UE 100 for the second operation pattern. It is assumed that, prior to this operation, the UE 100 has already joined a certain multicast session (referred to as “multicast session #1”), received a PTM configuration including a configuration of an MRB for RRC inactive state for receiving the multicast session #1 from the network 5, and established the MRB for RRC inactive state.

In step S21, the UE 100 in the RRC inactive state receives the multicast session #1 using the first MRB for RRC inactive state from the network 5.

In step S22, the UE 100 in the RRC inactive state performs the RRC connection resume with the network 5 to transition the RRC connected state. For example, the UE 100 performs the RRC connection resume due to reception of paging from the network 5, generation of uplink data, reception of deterioration of multicast reception quality, or the like. The RRC connection resume includes transmitting an RRC resume request message from the UE 100 to the gNB 200. The RRC resume request message has a Resume Cause field in which information indicating a cause for the RRC resume is set.

In step S23, the UE 100 determines whether the cause for the RRC resume is the PTM configuration update. For example, when the cause for the RRC resume is the reception of paging or the generation of uplink data, the UE 100 determines that the cause for the RRC resume is not the PTM configuration update.

To be more specific, the UE 100 determines that the cause for the RRC resume is the PTM configuration update in the following cases.
a) When the UE 100 receives a group paging:
   A case where the UE 100 receives a paging message from the network 5 and a Paging Group List in the paging message includes a TMGI of the multicast session the UE 100 is receiving.
b) When the multicast reception quality deteriorates:
   A case where the UE 100 measures multicast reception qualities (for example, reference signal received power (RSRP), reference signal received quality (RSRQ), block error rate (BLER), or the like), and the multicast reception qualities deteriorate compared to thresholds configured from the network 5, or the deterioration of the reception qualities is detected depending on UE implementation (for example, higher layer determination).
c) When a NAS procedure of multicast session leaves for leaving a multicast session is performed according to multicast session stop.
D) When the usage period of MRB for RRC inactive state expires:
   For example, a case where a timer indicating a valid period of the MRB for RRC inactive state expires, or a case of moving out of a valid area of the MRB for RRC inactive state (for example, moving out of the serving cell).

On the other hand, the UE 100 determines that the cause for the RRC resume is not the PTM configuration update in the following cases.
Emergency: originating an emergency call.
highPriorityAccess: originating high priority access having an operator defined Access Class.
mt-Access: reception of paging, particularly, not Group Paging, but a case where the existing Paging Record List includes the UE-ID (5G-S-TMSI) of the UE.
mo-Signalling: originating uplink signaling.
mo-Data: originating uplink data.
mo-VoiceCall: origination a voice call.
mo-VideoCall: originating a video call.
mo-SMS: originating SMS data.
ma-Update: RAN Notification Area Update.
mps-Priority Access: originating priority access of Multimedia Priority Service.
mcs-Priority Access: originating priority access of PriorityAccess Mission Critical Service.

If the cause for the RRC resume is the PTM configuration update (step S23: YES), in step S24, the UE 100 stops the reception processing of the multicast session #1 using the MRB for RRC inactive state, and discards or suspends the MRB for RRC inactive state.

On the other hand, if the cause for the RRC resume is not the PTM configuration update (step S23: NO), in step S25, the UE 100 maintains the MRB for RRC inactive state to continue the reception processing of the multicast session #1 using the MRB for RRC inactive state.

### (4) Other Embodiments

Although the multicast reception in the RRC inactive state has been mainly described in the above-described embodiments, the operations according to the above-described embodiments may also be applied to multicast reception in the RRC idle state. With respect to the RRC idle state, the above-described RRC resume (Resume) can be read as RRC establishment (Establishment).

The operation flows described above can be separately and independently implemented, and also be implemented in combination of two or more of the operation flows. For example, some steps of one operation flow may be added to another operation flow or some steps of one operation flow may be replaced with some steps of another operation flow. In each flow, all steps may not be necessarily performed, and only some of the steps may be performed.

Although the example in which the base station is an NR base station (gNB) has been described in the embodiments and examples described above, the base station may be an LTE base station (eNB) or a 6G base station. The base station may be a relay node such as an Integrated Access and Backhaul (IAB) node. The base station may be a DU of the IAB node. The UE 100 may be a Mobile Termination (MT) of the IAB node.

That is, the UE 100 may be a terminal function unit (a type of communication module) for a base station to control a repeater that performs signal relay. Such terminal function unit is referred to as an MT. Examples of the MT include, a Network Controlled Repeater (NCR)-MT, a Reconfigurable Intelligent Surface (RIS)-MT, in addition to the IAB-MT.

The term “network node” mainly means a base station, but may also mean a core network apparatus or a part (CU, DU, or RU) of the base station. The network node may include a combination of at least a part of the apparatus of the core network and at least a part of the base station.

A program causing a computer to execute each of the processing performed by the UE 100 or the gNB 200 may be provided. The program may be recorded in a computer-readable medium. Use of the computer-readable medium enables the program to be installed on a computer. Here, the computer-readable medium on which the program is recorded may be a non-transitory recording medium. The non-transitory recording medium is not particularly limited, and may be, for example, a recording medium such as a CD-ROM or a DVD-ROM. Circuits for executing processing performed by the UE 100 or the gNB 200 may be integrated, and at least a part of the UE 100 and the gNB 200 may be implemented as a semiconductor integrated circuit (chipset, System on a chip (SoC)).

The functions achieved by the UE 100 or the gNB 200 (the network node) may be implemented in a circuitry or a processing circuitry programmed to perform the described functions, including a general-purpose processor, a special-purpose processor, an integrated circuit, application specific integrated circuits (ASICs, a central processing unit (CPU), a conventional circuit, and/or combinations thereof. The processor may include transistors and other circuits and may be considered a circuitry or a processing circuitry. The processor may be a programmed processor that executes a program stored in the memory. As used herein, a circuitry, a unit, means are hardware programmed to achieve, or hardware performing, the described functions. The hardware may be any hardware disclosed herein or any hardware programmed to achieve or known to perform the described functions. When the hardware is a processor that is considered to be a type of circuitry, the circuitry, means, or a unit is a combination of hardware and software used to configure the hardware and/or the processor.

The phrases “based on” and “depending on/in response to” used in the present disclosure do not mean “based only on” and “only depending on/in response to” unless specifically stated otherwise. The phrase “based on” means both “based only on” and “based at least in part on”. The phrase “depending on” means both “only depending on” and “at least partially depending on”. The terms “include,” “comprise” and variations thereof do not mean “include only items stated” but instead mean “may include only items stated” or “may include not only the items stated but also other items.” The term “or” used in the present disclosure is not intended to be “exclusive or”. Any references to elements using designations such as “first” and “second” as used in the present disclosure do not generally limit the quantity or order of those elements. These designations may be used herein as a convenient method of distinguishing between two or more elements. Thus, a reference to first and second elements does not mean that only two elements may be employed there or that the first element needs to precede the second element in some manner. For example, when the English articles such as “a”, “an”, and “the” are added in the present disclosure through translation, these articles include the plural unless clearly indicated otherwise in context.

The embodiments have been described above in detail with reference to the drawings, but specific configurations are not limited to those described above, and various design variation can be made without departing from the gist of the present disclosure.

### (5) Supplementary Notes A

Features relating to the embodiments described above are described below as supplements.

### (Supplementary Note 1)

A communication method performed by a user equipment in a mobile communication system configured to provide a multicast/broadcast service (MBS), the communication method including:
receiving a multicast session in a radio resource control (RRC) inactive state from a network by using a first multicast radio bearer (MRB) for the RRC inactive state;
maintaining the first MRB until a predetermined condition is satisfied even after transitioning from the RRC inactive state to an RRC connected state; and
receiving point-to-multipoint (PTM) configuration in the RRC connected state from the network, the PTM configuration including a configuration of a second MRB for receiving the multicast session in the RRC connected state,
wherein the predetermined condition includes receiving, by the user equipment, the PTM configuration from the network.

### (Supplementary Note 2)

The communication method according to supplementary note 1, wherein the predetermined condition further includes establishing the second MRB based on the PTM configuration.

### (Supplementary Note 3)

The communication method according to supplementary note 2, wherein the predetermined condition further includes starting the receiving of the multicast session by using the second MRB.

### (Supplementary Note 4)

The communication method according to any one of supplementary notes 1 to 3, further including:
stopping the receiving of the multicast session using the first MRB in response to the predetermined condition being satisfied.

### (Supplementary Note 5)

The communication method according to supplementary note 4, wherein the stopping includes suspending or discarding the first MRB.

### (Supplementary Note 6)

A communication method performed by a user equipment in a mobile communication system configured to provide a multicast/broadcast service (MBS), the communication method including:
receiving a multicast session in a radio resource control (RRC) inactive state from a network by using a multicast radio bearer (MRB) for the RRC inactive state;
transitioning from the RRC inactive state to an RRC connected state;
stopping the receiving of the multicast session using the MRB even after transitioning to the RRC connected state based on a cause being update of a point-to-multipoint (PTM) configuration for the multicast session; and
continuing the receiving of the multicast session using the MRB even after transitioning to the RRC connected state based on a different cause from the cause.

### (Supplementary Note 7)

The communication method according to supplementary note 6, wherein the stopping includes suspending or discarding the MRB.

### (Supplementary Note 8)

The communication method according to supplementary note 6 or 7, wherein
the continuing includes maintaining the MRB.

### (6) Supplementary Notes B

### 1. Introduction

The work items for enhanced MBS (eMBS) are intended to support the multicast reception by the UE in the inactive state and described as follows.
To define support for the multicast reception by the UE in the RRC inactive state [RAN2, RAN3].
A PTM configuration for the UE that receives the multicast in the RRC inactive state [RAN2].
To investigate the impact of mobility and state transition of the UE receiving the multicast in the RRC inactive state (seamless/lossless mobility is not a requirement) [RAN2, RAN3].

RAN2 has discussed this purpose and reached a series of agreement items. Based on these agreement items, an aspect the control plane for multicast reception in the inactive state is discussed in the supplementary notes.

### 2. Discussion

### 2.1 Initial Configuration Procedure

RAN2 #120 has reached an agreement to advance the “mixed approach”.

The mixed approach is advanced as follows.
1. When the NW configures the UE to continue multicast reception in the inactive state, the NW provides the PTM configuration for the activated multicast session through RRC dedicated signaling to at least the serving cell (other cases need to be further studied).
2. The MCCH is used when the PTM configuration needs to be changed or when the PTM configuration needs to be indicated during migrating beyond the serving cell/gNB. The change of the session status and other indications need to be further studied.
3. Assume that the UE can receive the multicast service after joining the session.
4. Whether the MCCH configuration is initially provided to the UE through the dedicated signaling needs to be further studied.

RAN2 #121 agreed to the following description.
The UE needs to join the multicast session before receiving the multicast in RR inactive.
The network may configure the UE with the PTM configuration of the (single) serving cell before the session activation when the network determines that it is useful, and the UE may store the configuration. When the session is activated, the UE can apply the configuration to receive the multicast in the inactive state without returning to RRC connected unless updated by the MCCH after the configuration.
When the network configures the UE to receive multicast in the inactive state, the PTM configuration can be delivered using an RRC Release message including suspendconfig. No other dedicated RRC message is used to provide the PTM configuration of the MBS multicast in the inactive state.
A new MCCH logical channel for multicast in inactive (different from broadcast MCCH) is introduced.
The multicast MCCH configuration is provided via a new SIB.
Optionally, the multicast MCCH configuration for the serving cell can also be provided in dedicated signaling. Therefore, optimization is not performed for the mobility.

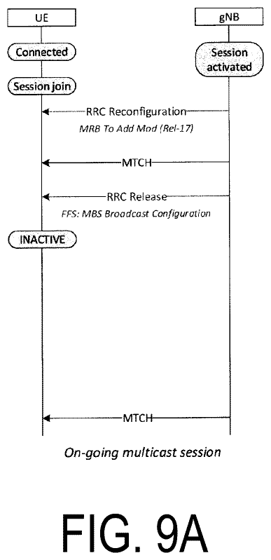

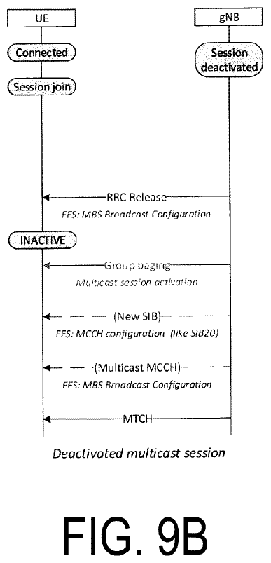

Based on these agreement items, the configuration procedure for an ongoing (i.e., activated) multicast session and a deactivated (i.e., before being activated) multicast session can be considered as in FIG. 9A and FIG. 9B.

### 2.1.1. Ongoing (Active) Multicast Session

For an ongoing multicast session, the UE configures a multicast MRB for multicast reception in connected by the RRC reconfiguration and starts receiving the MTCH as in Rel-1. For multicast reception in inactive, the UE configures a broadcast MRB for multicast reception (or a new “multicast inactive MRB”) via RRC release.

It is clear that the PTM configuration for RRC Resume has the same content (e.g., IE) as the Rel-17 MCCH (MBSBroadcastConfiguration) as a baseline. However, since RAN2 agreed on “introduction of a new MCCH logical channel”, the RRC message name also needs to be different from Rel-17 MBSBroadcastConfiguration. The same message is transferred via the new MCCH logical channel.

Proposal 1: RAN2 should agree to define a new RRC message for PTM configuration in the RRC release and to define a new “multicast MCCH”, e.g. MBSMulticastInactiveConfiguration.

Proposal 2: RAN2 should agree that the IE of the new RRC message for PTM configuration is the same as Rel-17 MBSBroadcastConfiguration as a baseline.

When the UE receives RRCRelease with suspendConfig as in Rel-1, the connected multicast MRB is suspended. The UE continues the same multicast session when the RRC release includes the PTM configuration in the inactive state. During/after the RRC state transition, service continuity of the multicast session needs to be ensured. This is similar to legacy dedicated configuration such as redirectedCarrierInfo, cellReselectionPriorities, deprioritisationReq, and measIdleConfig. The UE needs to start receiving the broadcast MRB as soon as applying the PTM configuration. Further study is needed as to whether a new procedure (i.e., the UE applies the PTM configuration and starts receiving the MTCH) is performed when the UE applies the suspendConfig.

Proposal 3: RAN2 should agree that before suspending the multicast MRB, the UE applies the PTM configuration of the broadcast MRB (or a new “multicast inactive MRB”) and starts receiving the corresponding MCCH.

### 2.1.2. Deactivated (Before Activated) Multicast Session

For a deactivated multicast session, the UE performs PTM configuration by the RRC release. In a case where the above proposal 3 can be agreed, the UE will immediately start receiving the MTCH, but since the MTCH is not transmitted at this time, the UE should refrain from this. Instead, the UE needs to be notified that the multicast session is still inactive via the RRC release so that the UE can wait for the multicast session activation notification without performing MTCH reception. Further study is needed as to the detailed operation, for example, whether to wait for the activation of the session while applying the PTM configuration can be decided.

Proposal 4: RAN2 should agree to notify the UE by RRC release whether the multicast session has been deactivated, so that the UE does not attempt to receive the corresponding MTCH.

After transitioning to inactive, the UE monitors a multicast session activation notification (i.e., group paging). Before the multicast session activation, the gNB may change the PTM configuration of the session, such change being configured by the new “multicast MCCH” of the UE in inactive. In this case, the gNB can transmit the “multicast MCCH” before the session activation.

From the perspective of the UE, when the UE needs to monitor a new “multicast MCCH” of the deactivated multicast session, power consumption of the UE increases. Therefore, the UE needs to confirm that the UE does not need to monitor the multicast MCCH before receiving the multicast session activation notification. In other words, the UE may only monitor the multicast MCCH upon receiving the activation notification with the TMGI of interest. The same operation can be applied to a new SIB (such as SIB20) for MCCH configuration.

Proposal 5: RAN2 should agree that the UE does not need to monitor a new “multicast MCCH” or a new SIB (such as SIB20) when the corresponding multicast session is deactivated (i.e., before receiving the multicast session notification).

Upon receiving the multicast activation notification, the UE needs to check whether the MCCH configuration in the new SIB and/or the PTM configuration in the multicast MCCH has been updated in a case where the MCCH configuration and/or the PTM configuration is provided from the RRC release. As long as the configuration is not updated, the stored configuration, i.e. the configuration provided by the RRC release, should be applied. Of course, in a case where the configuration is updated, the UE needs to acquire a new SIB and/or multicast MCCH.

For a new SIB, it is expected that the UE can know whether the new SIB has been updated by checking a value tag of the SIB1 as in the current situation. On the other hand, the UE does not know whether the multicast MCCH has been updated before receiving and decoding the MCCH. In this case, even in a case configured by the RRC release, the UE needs to decode the MCCH once anyway, which is also meaningless similarly. In this sense, in order for the UE to know the update of the PTM configuration without decoding the MCCH, the value tag needs to be introduced in the MCCH. Where the value tag of the MCCH is located, whether the value tag is located in a new SIB, a SIB1, or a group paging, etc., needs to be further studied.

Proposal 6: RAN2 should agree that an MCCH value tag is introduced that the UE uses to know whether the PTM configuration has been updated from that configured by the RRC release, without decoding the MCCH itself.

### 2.2. Update of Configuration in Inactive

In Rel-17, there exists one MCCH in a cell. In Rel-18, RAN2 agreed on “introduction of a new MCCH logical channel for multicast in inactive (different from broadcast MCCH)”. A multicast “MCCH is used when the PTM configuration needs to be changed or when the PTM configuration needs to be indicated during migrating beyond the serving cell/gNB.

Observation 1: A multicast MCCH is used to update the PTM configuration of the UE in inactive.

That is, in the Rel-18 network, there exist two MCCHs of a (broadcast) MCCH and a multicast MCCH. The motivation for introducing separate MCCHs in a cell may be to handle different service requirements of different cast types (MBS broadcast and MBS multicast).

The question is whether different multicast sessions also have different service requirements. The service requirements of the group multimedia call service and the firmware download service are considered to be quite different. For example, because the group multimedia call service is a foreground service, the PTM configuration needs to be frequently optimized, but because the firmware download service is a background service, such frequent optimization is not needed. Considering that the initial PTM configuration is provided by the RRC release, updating of the PTM configuration by multicast MCCH is needed for some services but not for other services. In this sense, introducing a plurality of multicast MCCHs is efficient for the UE and flexible for the network.

Proposal 7: RAN2 should discuss whether to introduce a plurality of multicast MCCHs per cell.

### 2.3. UE Mobility and Service Continuity

### 2.3.1. Prioritization of Frequencies

RAN2 #121bis-e agreed that further study is needed as to the operation of the UE upon cell reselection.
Similar to the Rel-17 broadcast reception procedure, the UE acquires a new SIB and multicast MCCH after the cell reselection and acquires PTM configuration.
In a case where the UE reselects a cell where no PTM configuration is available on the multicast MCCH, the UE initiates an RRC resume procedure for the active multicast session that is interested in receiving or continuing to receive.
Prioritization of frequencies may be provided to the UE for the cell reselection for multicast reception in the RRC inactive, but further study is needed as to the detailed mechanism for how to identify frequency information (e.g., SAI, USD, or frequency information provided directly from the network).
There is no need to define a mechanism other than the prioritization of frequencies, i.e., prioritization per cell in the cell reselection, so that the UE can select a suitable cell.
The neighbor cell list mechanism for multicast reception in the RRC inactive can be configured to be used by the UE to resume the RRC connection when no service is available in the reselected cell by the NCL without reading the MCCH in the reselected cell in some aspects similar to the Rel-17 NCL mechanism in MBS broadcast.

For frequency information, higher layers can provide the information, such as via the USD. However, considering that the NRMBS transmission is decided on a cell-by-cell basis, the RAN also needs to provide frequency information if possible, since the USD can only provide static information (especially for UE in inactive), while the RAN may have up-to-date information. Therefore, as in the SIB21 of Rel-17 MBS broadcast, the gNB can broadcast frequency information so that the UE can prioritize the appropriate frequency upon cell reselection.

Proposal 8: RAN2 should agree that the frequency information is broadcast by the gNB.

### 2.3.2 Area-specific PTM Configuration

In RAN2 #121, the area scope of the MCCH was discussed. Some companies propose to enhance the service continuity during the UE migration by enabling the PTM configuration in a plurality of cells. The PTM configurations for the respective cells can be easily matched (if necessary) for the intra-gNB, but difficult for the inter-gNB and negotiation with the Xn-AP is required. Finally, RAN2 agrees that the area scope does not involve other gNBs, and further study is needed for the intra-gNB.
The serving cell does not provide the PTM configuration of the neighbor cell from other gNBs.
Further study is needed as to whether the network can provide the PTM configuration to the intra-gNB cell.

This small function enhancement is considered no problem even if limited to the intra-gNB. Therefore, RAN2 needs to discuss whether the PTM configuration can be applied to a plurality of intra-gNB cells.

Proposal 9: RAN2 should discuss whether the PTM configuration can be applied to a plurality of intra-gNB cells.

### 2.3.3. QOS Enforcement

RAN2 #119e has reached the following agreement items relating to case 3.
HARQ feedback and PTP are not supported in the multicast reception in the RRC inactive.

According to the agreement items, the multicast reception in the inactive is the same as and/or similar to the MBS broadcast reception defined in Rel-17 (so-called delivery mode 2). The MBS broadcast is of the best-effort type.

On the other hand, ensuring QoS/reliability is an important issue for the multicast session. SA2 has also questioned whether there exists a difference in the qualities/reliabilities of multicast reception between the connected state and the inactive state, and RAN2 #119bis-e agreed on the following answers.

RAN2 Q1-a) in a case where there exists a large difference in the qualities/reliabilities of MBS data reception between the UE in the RRC connected state and the UE in the RRC inactive state, the qualities and the reliabilities of the MBS data reception between the UE in the RRC connected state and the UE in the RRC inactive state may be different because HARQ feedback and PTP transmission are not supported, and seamless/lossless mobility is not required for multicast reception in the RRC inactive state.

RAN2 #121bis-e agreed to introduce an event-triggered RRC resume mechanism, but further study is needed as to the trigger condition.

When the reception quality of the multicast data falls below a configured threshold, the UE may trigger the resume of the RRC connection.

RAN2 #119e has proposed to introduce threshold values for reception qualities such as RSRP and BLER, and the threshold values are considered to be used to ensure a certain level of QoS required for multicast reception.

As for the threshold for the RSRP, since the NR MBS assumes a single-cell transmission method, the MTCH in not directly monitored, and the SSB or the CSI-RS is monitored, the UE is considered to be required to always transition to the connected state every time the UE moves to a cell edge or performs the cell reselection. This operation may not be an optimal operation in some deployments from the viewpoint of the network congestion and the power saving of the UE. However, the RSRP is one of the basic metrics for evaluating the reception quality, and is one of the usual metrics when the gNB decides a handover (i.e., the handover is performed after the UE transitions to connected due to this RSRP threshold).

The threshold for a BLER is considered to be easy to understand to directly monitor the quality of the MTCH and ensure the QoS requirements. Therefore, the BLER is worth designating to the metrics.

Another way is to define specific events. For example, when an event is configured for the cell reselection, the UE always has to transition to the connected before the cell reselection. However, such an event can be emulated by the RSRP threshold described above. Therefore, when the RAN2 defines an event that is a trigger condition, careful consideration is required.

In summary, at least the RSRP threshold and/or the MTCH BLER threshold should be used for event-triggered RRC resume.

Proposal 10: RAN2 should agree to introduce RSRP threshold and/or MTCH BLER threshold to monitor the multicast reception quality and trigger the RRC resume.

### 2.4. Notifications

### 2.4.1. Deactivation of Multicast Session

In RAN2 #121bis-e, a method of notifying the UE of the session deactivation is discussed.
Further study is needed as to which option of group paging enhancement or MCCH enhancement to take in order to allow Rel-18 UEs to remain in the RRC inactive and stop monitoring the corresponding G-RNTI during a session deactivation/temporary no-data event.

In the above agreement items, only enhanced group paging or enhanced MCCH can be confirmed, but the new MAC CE is not explicitly excluded. Only the key points of the analysis of these options are summarized in Table 1.

TABLE 1

| | Group paging | | |
|---|---|---|---|
| | enhancement | Enhanced MCCH | New MAC CE |
| Legacy baseline | Unusable | Available in LTE MBMS | Available in LTE |
| mechanisms | | (Assuming that PTM configuration is | SC-PTM |
| | | deleted when session is disabled) | (SC-PTM stop |
| | | Unavailable | indication MAC |
| | | (Assuming that deactivation | CE) |
| | | indication is introduced) | |
| Logical channel | PCCH | MCCH | MTCH |
| Delay after | Middle | Long | Short |
| stopping MTCH | | | |
| Additional UE | Nothing | Nothing | Nothing |
| activity | UE needs to always | UE needs to always | UE has received |
| (other than MTCH | monitor PO | monitor MCCH | MTCH |
| reception) | | | |

Among the three options, the MAC CE is considered to be the most efficient in terms of UE power consumption (i.e., due to the shortest delay). However, as a result of discussion by electronic mail, there exist few consenters to this option.

Among the two possible options, the enhanced group paging is slightly more advantageous also in terms of UE power consumption. Based on legacy operation, the MCCH needs to delete the PTM configuration of the deactivated session. Considering that this multicast session is active again (since it has not been released), the enhanced MCCH needs to add the same PTM configuration again, and the UE needs to re-acquire and apply this configuration. What is enhanced with the enhanced MCCH is not clear. Assuming that a deactivation notification is added to the MCCH (same and/or similar notification is added in the enhanced group paging), this notification is delayed so that the UE receives it after the session is actually deactivated. Therefore, the group paging is considered to be valid.

Proposal 11: RAN2 should agree on the enhanced group paging for multicast session deactivation.

For the details of function enhancement of the group paging, backward compatibility needs to be considered. Since the existing paging group list (i.e., a list of TMGIs) is applicable to legacy UEs, the group paging needs to add a new TMGI list for deactivation notification to avoid an influence on the legacy UEs.

Proposal 12: in a case where the Proposal 11 can be agreed, RAN2 further discusses whether to create a new paging group list configured with the TMGI of the deactivated multicast session.

### 2.4.2. Multicast Session Activation and Selective Transition

RAN2 #119e reached the assumption that the gNB can select a subset of UEs transitioning between inactive and connected.
It is assumed that the network can select which UE receives in the RRC inactive state and in the RRC connected state, and can move the UE between the states for the multicast service reception.

RAN2 #121bis-e agreed to enhance the group paging of session activation notifications.
The Rel-18 UE may remain in the RRC inactive state and start monitoring the corresponding G-RNTI when an enhanced group paging (such as session activation or resume of data transmission) occurs. For the details, further studies are needed.
Legacy group paging (i.e., Rel-17 group paging) may be used to return the UE to the RRC connected state.
A specific MBS multicast UE can be transitioned to the RRC connected (i.e., legacy UE operation) using UE-specific paging (such as PagingRecordList).
When the UE receives both enhanced group paging and unicast paging (and this UE us targeted), the UE follows the unicast paging and transitions to the RRC connected.

As to the enhancement for the group paging, considering that a subset of UEs remains inactive while another subset transitions to connected, the operation of the UE upon receiving the current paging message (i.e., UE-specific paging and group paging) is as follows.
UE-specific paging: The UE transitions to connected when its UE-ID is available in pagingRecordList.
Group Paging: When a TMGI of interest becomes available in pagingGroupList, all UEs transition to connected.
Paging message: pagingRecordList and pagingGroupList can be configured simultaneously (i.e., in one message) in terms of ASN.1. In any case, all UEs transition to connected when the TMGI of interest becomes available in pagingGroupList, regardless of pagingRecordList.

Therefore, the gNB cannot leave the subset of UEs in the inactive state as long as these UEs are interested in the TMGIs available in pagingGroupList.

Therefore, in the Rel-18 function enhancement, the operation of the UE upon receiving the group paging needs to be changed. A simple way is to cancel legacy pagingGroupList, where legacy pagingGroupList is always needed for the Rel-17 UEs (i.e. backward compatibility). Since the cancellation needs to be performed for each TMGI, an additional TMGI list is required (e.g., Paging Group Cancel List is constituted by the TMGIs). Considering the RAN2 agreement item “when both enhanced group paging and unicast paging are received by a UE (and this UE is targeted), the UE follows the unicast Paging and becomes RRC connected”, the operation of the Rel-18 UE is as follows.

Step 1: The UE receives a paging message including pagingRecordList, pagingGroupList, and a new TMGI cancellation list.

Step 2: Since pagingGroupList includes the TMGI of interest, the UE is considered to have been paged by the group paging, as in Rel-17.
Step 3: Since the new TMGI cancellation list includes the TMGI of interest (that is, the same TMGI), the UE considers that the group paging is canceled.
Step 4: Since pagingRecordList includes the UE-ID, the UE considers that it has been paged by the UE-specific paging, and transitions to the connected state as in Rel-17.
Step 5: The gNB configures the UE with multicast MRB as in Rel-17.

Finally, only a subset of UEs transition to connected for multicast reception.

Proposal 13: RAN2 should agree to add a new cancel TMGI list to the group paging to cancel the Rel-17 group paging.

Further study is needed as to the “special UE” in RAN2 #121bis-e.
The “special UE” identified by the MBS assistance information from the 5GC may be released to RRC inactive (such as when the session is deactivated). Further study is needed as to what to do to allow the network to return to RRC connected when such a UE activates the session.

That is, pagingRecordList includes the UE-ID of the “special UE”, and pagingGroupList and the new TMGI cancellation list include the TMGIs of interest of the “special UE”. Thus, enhancement for this is not needed.

Observation 2: The new TMGI cancel list also works for the “special UE” at session activation.

2.4.3. Update of PTM configuration

RAN2 #120 agreed to use the MCCH when the PTM configuration needs to be updated.
The mixed approach proceeds as follows.
5. When the NW configures the UE to continue multicast reception in the inactive state, the NW provides the PTM configuration for the activated multicast session through RRC dedicated signaling to at least the serving cell (other cases need to be further studied).
6. The MCCH is used when the PTM configuration needs to be changed or when the PTM configuration needs to be indicated during migrating beyond the serving cell/gNB. The change of the session status and other indications need to be further studied.
7. Assume that the UE can receive the multicast service after joining the session.
8. Whether the MCCH configuration is initially provided to the UE through dedicated signaling needs to be further studied.

RAN2 #121 agreed to use the RRC release for the PTM configuration (even before the session activation) and to introduce a new MCCH (different from Rel-17 MCCH).
The UE needs to join the multicast session before receiving the multicast in the RRC inactive.
The network may configure the UE with the PTM configuration of the (single) serving cell before the session activation when the network determines that it is useful, and the UE may store the configuration. When the session is activated, the UE can apply the configuration to receive the multicast in the inactive state without returning to RRC connected unless updated by the MCCH after the configuration.
When the network configures the UE to receive multicast in the inactive state, the PTM configuration can be delivered using an RRC Release message including suspendconfig. No other dedicated RRC message is used to provide the PTM configuration of the MBS multicast in the inactive state.
A new MCCH logical channel for multicast in inactive (different from broadcast MCCH) is introduced.

According to these agreement items, there exist two cases for PTM configuration update.
Case 1: For the UE in inactive receiving already activated multicast session
Case 2: For the UE in inactive waiting for activation of multicast session
   Note: Case 2 may be further classified according to whether the PTM configuration has been provided by the RRC release.
   In such a case, the solutions are desirably as common as possible.

Proposal 14: RAN2 should aim at the common solution for the notification of the PTM configuration update, considering at least two cases of an already activated session and a session before activation.

The motivation for using the MCCH is to reduce the signaling overhead upon updating the PTM configuration, i.e., to allow the UE to remain in the inactive state to obtain the updated PTM configuration. Therefore, when viewed from the UE in the inactive state, the delivery method of the new PTM configuration in the Rel-18 is similar to the Rel-17 delivery mode 2. In this case, it is considered reasonable to reuse the existing MCCH change notification to perform notification of the update of the PTM configuration.

However, the MCCH Change Notification requires the UE to wake up once per MCCH change boundary, which puts additional load in addition to the monitoring of paging occasions. Also, the MCCH Change Notification is not efficient, especially in case 2 above (i.e. the UE needs to monitor the MCCH Change Notification just waiting for the multicast session notification to confirm whether the PTM configuration provided by the RRC release has been updated).

To solve such problem, the group paging can be enhanced for notification of the PTM configuration update. The UE only needs to monitor the paging occasion to determine whether the PTM configuration has been updated, regardless of whether the UE is receiving a multicast session (i.e., case 1 or case 2 above). Therefore, RAN2 needs to agree to use the group paging for this notification. Further study is needed as to the details of the function enhancement.

Proposal 15: RAN2 should agree to use the group paging for the update of the PTM configuration instead of the existing MCCH change notification.

2.5 Service Continuity upon RRC Resume

The possibility that the UE having already received a multicast session in inactive (i.e., via a broadcast MRB or a new MRB for multicast reception in inactive) is paged and initiates the RRC Resume procedure needs to be considered. After transitioning to connected, the UE of course wants to continue to receive the multicast session. However, in this case, the UE has two MRBs for the same multicast session, namely a broadcast MRB (or a new MRB) configured for multicast reception in inactive and a multicast MRB resumed for multicast reception in connected.

In Rel-17, a multicast session can receive only via a multicast MRB configured by an RRC reconfiguration. On the other hand, in Rel-18, it is considered that the UE can receive a multicast session via a Broadcast MRB (or a new MRB) configured by an RRC reconfiguration or a new MCCH.

The UE needs to use the multicast MRB for reception after transitioning to connected (as in Rel-17). However, it is not clear how the UE switches these MRBs, when the UE discards the broadcast MRB (or new MRB), how the UE should operate when the multicast MRB is an AM MRB (i.e., in terms of lossless principle) and the like. Therefore, RAN2 needs to discuss the operation of the UE upon RRC resume in terms of processing of the MRB and service continuity of the multicast session.

Proposal 16: RAN2 should discuss the operation of the UE that is continuing to receive the multicast session upon RRC resume (such as processing of broadcast MRB and multicast MRB).

### REFERENCE SIGNS

1: Mobile communication system
5: Network
10: RAN
20: CN
100: User equipment (UE)
110: Receiver
120: Transmitter
130: Controller
200: gNB (Base station)
210: Transmitter
220: Receiver
230: Controller
240: Backhaul communicator

1. A communication method performed by a user equipment in a mobile communication system for providing a multicast/broadcast service (MBS), the communication method comprising:
receiving a multicast session in a radio resource control (RRC) inactive state from a network by using a first multicast radio bearer (MRB) for the RRC inactive state;
maintaining the first MRB until a predetermined condition is satisfied even after transitioning from the RRC inactive state to an RRC connected state; and
receiving point-to-multipoint (PTM) configuration in the RRC connected state from the network, the PTM configuration comprising a configuration of a second MRB for receiving the multicast session in the RRC connected state,
wherein the predetermined condition comprises receiving, by the user equipment, the PTM configuration from the network.

2. The communication method according to claim 1, wherein
the predetermined condition further comprises establishing the second MRB based on the PTM configuration.

3. The communication method according to claim 2, wherein
the predetermined condition further comprises starting the receiving of the multicast session by using the second MRB.

4. The communication method according to claim 1, further comprising:
stopping the receiving of the multicast session using the first MRB in response to the predetermined condition being satisfied.

5. The communication method according to claim 4, wherein
the stopping comprises suspending or discarding the first MRB.

6. A communication method performed by a user equipment in a mobile communication system for providing a multicast/broadcast service (MBS), the communication method comprising:
receiving a multicast session in a radio resource control (RRC) inactive state from a network by using a multicast radio bearer (MRB) for the RRC inactive state;
transitioning from the RRC inactive state to an RRC connected state;
stopping the receiving of the multicast session using the MRB even after transitioning to the RRC connected state based on a cause being update of a point-to-multipoint (PTM) configuration for the multicast session; and
continuing the receiving of the multicast session using the MRB even after transitioning to the RRC connected state based on a different cause from the cause.

7. The communication method according to claim 6, wherein
the stopping comprises suspending or discarding the MRB.

8. The communication method according to claim 6, wherein
the continuing comprises maintaining the MRB.

9. A user equipment used in a mobile communication system for providing a multicast/broadcast service (MBS), the user equipment comprising:
a receiver configured to receive a multicast session in a radio resource control (RRC) inactive state from a network by using a first multicast radio bearer (MRB) for the RRC inactive state, and
a controller configured to maintain the first MRB until a predetermined condition is satisfied even after transitioning from the RRC inactive state to an RRC connected state, wherein
the receiver is configured to receive point-to-multipoint (PTM) configuration in the RRC connected state from the network, the PTM configuration comprising a configuration of a second MRB for receiving the multicast session in the RRC connected state, and
the predetermined condition comprises receiving, by the user equipment, the PTM configuration from the network.
